(19) United States
(12) Patent Application Publication
(10) Pub. No.: US 2026/0188176 A1
(43) Pub. Date: Jul. 2, 2026

(54) DISPLAY DEVICE

(71) Applicant: LG Display Co., Ltd., Seoul (KR)

(72) Inventors: Seounghak LEE, Seoul (KR); SungJun YUN, Paju-si (KR)

(73) Assignee: LG Display Co., Ltd., Seoul (KR)

(21) Appl. No.: 19/426,758

(22) Filed: Dec. 19, 2025

(30) Foreign Application Priority Data
Dec. 30, 2024 (KR) 10-2024-0200091

(51) Int. Cl. G09G 3/20

(52) U.S. Cl. CPC G09G 3/2096; G09G 3/2007; G09G 2310/0289; G09G 2310/08; G09G 2330/023

(57) ABSTRACT

In one or more examples, a display device includes a timing controller for generating image data, a data control signal, and a gate control signal, a data driver for generating data signals corresponding to the image data based on the image data and the data control signal and outputting the data signals to data lines, and a gate driver for generating gate signals based on the gate control signal and outputting the gate signals to gate lines. The timing controller stops transmitting image data in a section in which the low power driving signal is at a logic high level, and the gate driver modulates a gate signal having a turn-on level pulse in which the low power driving signal among the gate signals overlaps the section in which the low power driving signal is at the logic high level.

### CROSS-REFERENCE TO RELATED APPLICATIONS

This application claims the benefit of and priority to Korean Patent Application No. 10-2024-0200091 filed on Dec. 30, 2024, in the Korean Intellectual Property Office, the entire contents of which are incorporated herein by reference for all purposes.

### BACKGROUND

### 1. Technical Field

The present disclosure relates to a display device, and particularly to, for example, without limitation, a display device capable of low-power transmission driving.

### 2. Description of Related Art

The display device includes a liquid crystal display (LCD), an electroluminescent display (electroluminescent display), and a quantum dot display (QD). The electroluminescent display device may be divided into an inorganic light emitting display device and an organic light emitting display device according to the material of the light emitting layer.

A low power Tx driving (LPTD) is being developed as a way to reduce power consumption in such a display device. When low power transmission driving is activated, when two or more pixel rows display images of the same gray scale in the area covered by the source driving integrated circuit, the source driving integrated circuit stores image data in a memory. The source driving integrated circuit may periodically read the image data stored in the line buffer and transmit the image data to the display panel. While images of the same grayscale are displayed in the pixel rows, image data is not transmitted from the timing controller to the source driving integrated circuit. Accordingly, power consumption of the timing controller may be reduced in low power transmission driving.

The description of related art should not be considered prior art merely because it is mentioned in or associated with this section. The description of related art includes information that describes one or more aspects of the subject technology, and the description in this section does not limit the scope of the present disclosure.

### SUMMARY

An aspect of the present disclosure provides a display device capable of minimizing power consumption.

Aspects of the present disclosure are not limited to the above-mentioned aspects, and other aspects, which are not mentioned above, can be clearly understood by those skilled in the art from the following descriptions.

According to an aspect of the present disclosure, a display device includes a timing controller configured to generate image data, a data control signal, and a gate control signal, a data driver configured to generate a plurality of data signals corresponding to the image data and output the data signals to a plurality of data lines based on the data control signal, a gate driver configured to generate a plurality of gate signals and output the gate signals to a plurality of gate lines, and a display panel including a plurality of pixels disposed in the display area and connected to the plurality of data lines and the plurality of gate lines, wherein the timing controller stops transmission of the image data in a section in which the low power driving signal is a logic high level, and the gate driver may modulate a gate signal having a turn-on level pulse in which the low power driving signal among the plurality of gate signals overlaps the section in which the low power driving signal is a logic high level.

According to an aspect of the present disclosure, a display device includes a timing controller configured to generate image data, a data control signal, and a gate control signal; a data driver configured to generate a plurality of data signals corresponding to the image data based on the image data and the data control signal; and a gate driver configured to generate a plurality of gate signals based on an on clock signal and an off clock signal included in the gate control signal, wherein the timing controller stops transmission of the image data in a section in which the low power driving signal is a logic high level, and the timing controller may modulate a pulse in which the low power driving signal overlaps the logic high level, among a plurality of pulses included in the off clock signal.

Other detailed matters of the embodiments are included in the detailed description and the drawings.

According to one or more aspects of the present disclosure, when a plurality of pixel rows display an image of the same gradation, transmission of image data corresponding to at least some of a plurality of pixel rows displaying an image of the same gradation may be stopped. Accordingly, power consumption for data transmission may be reduced.

In addition, during a period in which image data transmission is stopped, the present disclosure may shift the off clock signal for generating the gate signal in a specific direction. Accordingly, the falling edge of the gate signal is shifted in response to the off clock signal to reduce the pulse width of the gate signal, so that the power consumption of the gate driver may be further reduced.

Further, during a period in which the image data transmission is stopped, the present disclosure may increase a pulse width of an off clock signal for generating a gate signal. Accordingly, the gate pulse modulation (GPM) section increases at the falling edge of the gate signal in response to the pulse width of the off clock signal, so that the power consumption of the gate driver may be further reduced.

The effects according to the embodiments of the present disclosure are not limited to the contents described above, and more various effects are included in the present disclosure.

### BRIEF DESCRIPTION OF DRAWINGS

The accompanying drawings, which are included to provide a further understanding of the present disclosure, are incorporated in and constitute a part of this present disclosure, illustrate aspects and embodiments of the present disclosure, and together with the description serve to explain principles and examples of the disclosure.

FIG. 1 is a block diagram of a display device according to an example embodiment of the present disclosure.

FIG. 2 is a block diagram illustrating an example of a timing controller, a data driver, and a display panel included in a display device of FIG. 1.

FIG. 3 is a block diagram illustrating an example of a timing controller and a data driver included in a display device of FIG. 1.

FIG. 4 is a diagram for describing an example of low power transmission driving of the display device of FIG. 1.

FIG. 5 is a block diagram illustrating an example of a timing controller and a gate driver included in a display device of FIG. 1.

FIGS. 6A to 6C are waveform diagrams illustrating an example of the operation of the gate driver of FIG. 5.

FIGS. 7A and 7B are waveform diagrams illustrating an example of a low-power exclusive driving operation of the timing controller and the gate driver of FIG. 5.

FIGS. 8A and 8B are waveform diagrams illustrating another example of a low-power exclusive driving operation of the timing controller and the gate driver of FIG. 5.

### DETAILED DESCRIPTION

Advantages and characteristics of the present disclosure and a method of achieving the advantages and characteristics will be clear by referring to example embodiments described below in detail together with the accompanying drawings. However, the present disclosure is not limited to the example embodiments disclosed herein but will be implemented in various forms. The example embodiments are provided by way of example only so that those skilled in the art can fully understand the disclosures of the present disclosure and the scope of the present disclosure.

The shapes, sizes, ratios, angles, numbers, and the like illustrated in the accompanying drawings for describing the example embodiments of the present disclosure are merely examples, and the present disclosure is not limited thereto. Further, in the following description of the present disclosure, a detailed explanation of known related technologies may be omitted to avoid unnecessarily obscuring the subject matter of the present disclosure. The terms such as “including”, “having”, and “consist of” used herein are generally intended to allow other components to be added unless the terms are used with the term “only”. Any references to singular may include plural unless expressly stated otherwise. In one or more examples, unless expressly stated otherwise, an element may be one or more elements; and an element may include a plurality of elements. The word “exemplary” is used to mean serving as an example or illustration. Embodiments are example embodiments. Aspects are example aspects. In one or more implementations, “embodiments,” “examples,” “aspects,” and the like should not be construed to be preferred or advantageous over other implementations. An embodiment, an example, an example embodiment, an aspect, or the like may refer to one or more embodiments, one or more examples, one or more example embodiments, one or more aspects, or the like, unless stated otherwise.

Components are interpreted to include an ordinary error range even if not expressly stated.

When the position relation between two parts is described using the terms such as “on”, “above”, “below”, and “next”, one or more parts may be positioned between the two parts unless the terms are used with the term “immediately” or “directly”.

When an element or layer is disposed “on” another element or layer, another layer or another element may be interposed directly on the other element or therebetween.

Although the terms “first”, “second”, and the like are used for describing various components, these components are not confined by these terms. These terms are merely used to refer to one element separately from another. Therefore, a first component to be mentioned below may be a second component in a technical concept of the present disclosure.

Like reference numerals generally denote like elements throughout the disclosure.

A size and a thickness of each component illustrated in the drawing are illustrated for convenience of description, and the present disclosure is not limited to the size and the thickness of the component illustrated.

The features of various embodiments of the present disclosure can be partially or entirely adhered to or combined with each other and can be interlocked and operated in technically various ways, and the embodiments can be carried out independently of or in association with each other.

Hereinafter, example embodiments of the present disclosure will be described in detail with reference to accompanying drawings.

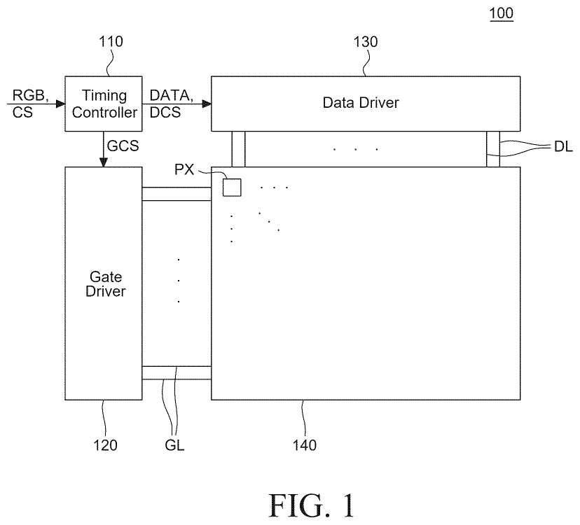

FIG. 1 is a block diagram of a display device according to an example embodiment of the present disclosure.

Referring to FIG. 1, a display apparatus 100 according to an example embodiment of the present disclosure may include a timing controller 110, a gate driver 120, a data driver 130, and a display panel 140.

The display panel 140 may generate an image to be provided to a user. For example, the display panel 140 may include a plurality of pixels PX in which pixel circuits are disposed, respectively. Each of the plurality of pixels PX is connected to a corresponding gate line GL and a corresponding data line DL to display an image in response to a gate signal provided to the gate line GL and a data signal provided to the data line DL.

The timing controller 110 may control the gate driver 120 and the data driver 130 based on an input image RGB and a control signal CS provided from the outside, for example, a host system. For example, the input control signal CS includes timing signals such as a horizontal synchronization signal, a vertical synchronization signal, a data enable signal, and a clock signal and the timing controller 110 may generate a gate control signal GCS and a data control signal DCS based on the control signal CS. The gate control signal GCS may be provided to the gate driver 120, and the data control signal DCS may be provided to the data driver 130.

Further, the timing controller 110 rearranges the input image RGB in the digital video data format to match the resolution of the display panel 140 to generate image data DATA and provide the image data to the data driver 130.

According to an embodiment, the timing controller 110 may transmit and receive signals to and from other components through one or more predetermined interfaces. For example, the interface may include an Embedded Clock Point-Point Interface (EPI). In this case, the timing controller 110 may configure the data control signal DCS and the image data DATA in an EPI transmission format and then provide the data control signal DCS and the image data DATA to the data driver 130. However, the embodiment of the present disclosure is not limited thereto, and the interface may include a serial personal interface (SPI) and a low voltage differential signaling (LVDS) interface.

The gate driver 120 may generate a gate signal based on the gate control signal GCS and output the gate signal to a plurality of gate lines GL. For example, the gate driver 120 may sequentially output gate signals to the plurality of gate lines GL in units of pixel rows.

In an embodiment, the gate driver 120 may include a level shifter. For example, the gate control signal GCS includes an on clock signal, an off clock signal, a start signal, and the like, and the level shifter may generate a plurality of gate clock signals and a gate start signal based on the on clock signal, the off clock signal, the start signal, and the like. The gate driver 120 may generate a plurality of gate signals based on a plurality of gate clock signals and gate start signals generated by the level shifter.

The data driver 130 converts digital image data DATA provided from the timing controller 110 into an analog data signal based on the data control signal DCS to supply the analog data signal to the plurality of data lines DL.

For example, the data driver 130 may generate a sampling signal according to the data control signal DCS, latch the image data DATA according to the sampling signal to convert the image data DATA into an analog data signal (data voltage), and then supply the data signal to the plurality of data lines DL. For example, the data control signal DCS may include a data clock signal, a line latch signal, and the like for generating a data signal.

In an embodiment, the data driver 130 may include at least one source driving integrated circuit. Here, each of the at least one source driving integrated circuit included in the data driver 130 may separate the data control signal DCS and the image data DATA in the EPI transmission format transmitted from the timing controller 110.

Further, each of the at least one source driving integrated circuit included in the data driver 130 generates a data signal based on the data control signal DCS and the image data DATA and supplies the data signal to the plurality of data lines DL through the plurality of channels.

In an embodiment, the display device 100 may operate in a low power transmission driving (LPTD) mode. For example, the timing controller 110 may detect whether two or more pixel rows among a plurality of pixel rows included in the display panel 140 display the same gray scale on the basis of the input image RGB input from the outside, for example, the host system. When two or more pixel rows display the same gray scale, the low power transmission driver of the timing controller 110 transmits the image data DATA to the data driver 130 in response to the first pixel row among two or more pixel rows displaying the same gray scale, and then stops transmitting the image data DATA to the data driver 130 for a period corresponding to the remaining pixel rows. Accordingly, power consumption due to data transmission of the timing controller 110 may be reduced.

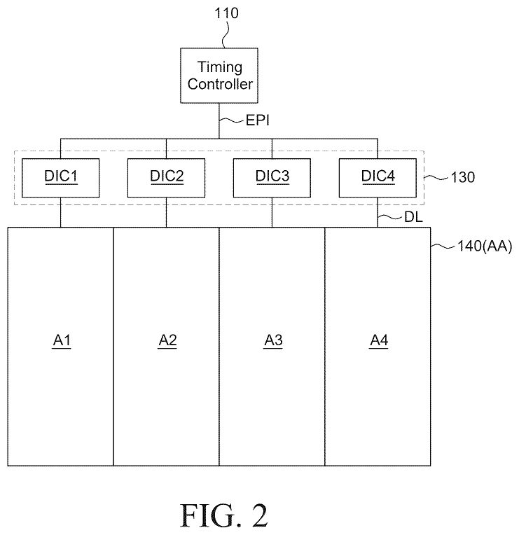

For a more detailed description of such a low-power transmission driving method, reference may be made to FIGS. 2 to 4.

FIG. 2 is a block diagram illustrating an example of a timing controller, a data driver, and a display panel included in a display device of FIG. 1.

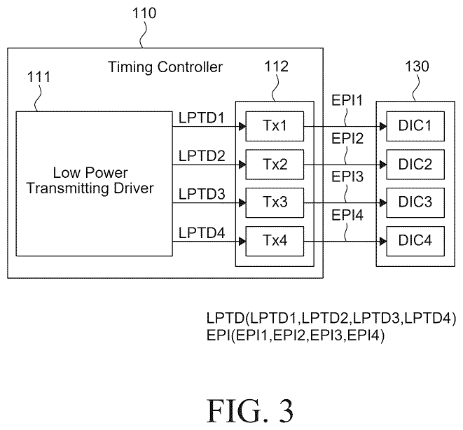

FIG. 3 is a block diagram illustrating an example of a timing controller and a data driver included in a display device of FIG. 1.

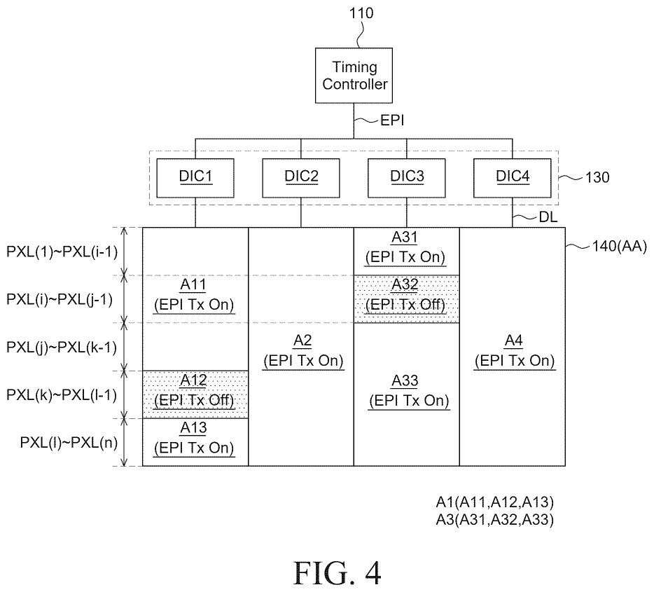

FIG. 4 is a diagram for describing an example of low power transmission driving of the display device of FIG. 1.

Meanwhile, FIG. 2 illustrates an example in which the data driver 130 includes four source driving integrated circuits DIC1 to DIC4. However, this is provided for illustrative purposes only, and the number of source driving integrated circuits DIC1 to DIC4 included in the data driver 130 may be determined depending on the size and resolution of the display panel 140. Hereinafter, for convenience of description, it will be described that the data driver 130 includes four source-driven integrated circuits DIC1 to DIC4.

Referring to FIGS. 1 and 2, the timing controller 110 may be connected to a plurality of source driving integrated circuits DIC1 to DIC4 included in the data driver 130 through at least one interface EPI.

For example, referring to FIG. 3 together, each of a plurality of transmitters Tx1 to Tx4 included in the transmitter 112 of the timing controller 110 may be connected to a plurality of source driving integrated circuits DIC1 to DIC4 included in the data driver 130 through a plurality of interfaces EPI1 to EPI4, for example, an EPI line pair, in the form of 1:1, that is, point-to-point.

More specifically, the image data DATA and the data control signal DCS generated based on the input image RGB of the timing controller 110 are converted into serial data and provided to a plurality of source driving integrated circuits DIC1 to DIC4 included in the data driver 130 through the interface EPI connected to the transmitter 112. To this end, the transmitter 112 included in the timing controller 110 may include a plurality of transmitters Tx1 to Tx4 corresponding to the number of source driving integrated circuits DIC1 to DIC4. That is, each of the plurality of transmitters Tx1 to Tx4 included in the transmitter 112 of the timing controller 110 is connected to the corresponding source-driven integrated circuits DIC1 to DIC4 through the plurality of interfaces EPI1 to EPI4 to transmit the serial data-type image data DATA and the data control signal DCS to the source-driven integrated circuit DIC1 to DIC4.

Each of the plurality of source driving integrated circuits DIC1 to DIC4 included in the data driver 130 may include a register, a latch, a digital-to-analog converter, an output buffer, and the like.

Each of the source-driven integrated circuits DIC1 to DIC4 may receive the data control signal DCS and the image data DATA from the timing controller 110 through corresponding interfaces EPI1 to EPI4 and generate a data signal based on the data control signal.

For example, each of the source-driven integrated circuits DIC1 to DIC4 restores a clock from a signal provided from the timing controller 110 through corresponding interfaces EPI1 to EPI4 and fixes the phase and frequency of the internal clock to output a lock signal, and the timing controller 110 may provide a data packet including image data (DATA) and a data control signal (DCS) to corresponding source-driven integrated circuits DIC1 to DIC4 through respective interfaces EPI1 to EPI4 when a lock signal is received from the last source-driven integrated circuit.

The display area AA of the display panel 140 may include a plurality of display areas A1 to A4 each corresponding to one source-driven integrated circuit DIC1 to DIC4, for example, each connected to one source-driven integrated circuit DIC1 to DIC4 to receive a data signal. The pixels PX disposed in each of the display areas A1 to A4 may display images based on data signals output from corresponding source-driven integrated circuits DIC1 to DIC4.

In an embodiment, as described above, when the display device 100 operates in the low power transmission driving mode, the timing controller 110 may stop data transmission to at least one of a plurality of source driving integrated circuits DIC1 to DIC4 included in the data driver 130.

For example, referring to FIG. 3, the timing controller 110 may include a low-power transmission driver 111 and a transmission unit 112. The low-power transmission driver 111 may provide a low-power driving signal LPTD to the transmitter 112. Here, depending on the signal level of the low power driving signal LPTD, whether to stop the data transmission from the transmitter 112 to the data driver 130 through the interface EPI may be determined.

For example, the low-power transmission driver 111 may provide the first low-power driving signal LPTD1 to the first transmitter Tx1, provide the second low-power driving signal LPTD2 to the second transmitter Tx2, provide the third low-power driving signal LPTD3 to the third transmitter Tx3, and provide the fourth low-power driving signal LPTD4 to the fourth transmitter Tx4. Here, each of the plurality of transmitters Tx1 to Tx4 of the transmitter 112 may determine whether to stop data transmission through the interface EPI based on a signal level of a corresponding low power driving signal LPTD. For example, each of the plurality of transmitters Tx1 to Tx4 may stop data transmission to the corresponding interfaces EPI1 to EPI4 when the signal level of the corresponding low power driving signal LPTD is a logical high level, stop data transmission to the corresponding interfaces EPI1 to EPI4, and when the signal level of the low power driving signal LPTD is a logical low level, transmit the image data DATA and the data control signal DCS to the corresponding source driving integrated circuit DIC1 to DIC4 through the corresponding interfaces EPI1 to EPI4.

To describe a low-power transmission driving method in more detail with reference to FIG. 4 together, when a plurality of pixels PX disposed in the display area AA of the display panel 140 is disposed in a plurality of pixel rows PXL(1) to PXL(n) (wherein n is an integer greater than 0), the timing controller 110 may transmit image data DATA corresponding to a first pixel row of two or more pixel rows displaying an image of the same gray scale to the data driver 130 when two or more pixel rows among the plurality of pixel rows PXL(1) to PXL(n) display an image of the same gray scale, and then stop the transmission of the image data DATA to the remaining pixel rows.

For example, as illustrated in FIG. 4, the 3-1-th display area A31 corresponding to the first to (i-1)-th pixel rows PXL(1) to PXL(i−1) of the third display area A3 of the display area AA (where i is an integer greater than 0 and less than n) displays images of various gray scales, the 3-1-th display area A31 corresponding to the (j is an integer greater than i and less than n) of the third display area AA displays images of the same gray scale, and the 3-1-th display area A32 corresponding to the (i)-th to (j−1) pixel rows PXL(i) to PXL(j−1) of the third display area A3 is displayed with data corresponding to the 3rd display area T3(n) of the third display area A3, and the 3rd display area DATA3 is displayed with data corresponding to the 3rd timing controller corresponding to at least partially to the 3rd display area T3(n) of the third display area DI3(n−3 corresponding to T3(n) of the third display area DI3(n) of the third display area DI3 is displayed with data corresponding to the third display area DI3

For example, the third transmitter Tx3 included in the transmitter 112 of the timing controller 110 may transmit the image data DATA of the i-th pixel row PXL(i) to the third source driving integrated circuit DIC3 through the third interface EPI3 in the i-th horizontal period in one frame.

Further, during the horizontal period when the image data DATA of the remaining pixel rows, e.g., the (i+1)-th to (j−1)-th pixel rows PXL(i+1)-PXL(j−1) displaying the same gray scale of the 3-2-th display area A32 should be transmitted, the third transmitter Tx3 may be driven at low power by stopping the transmission of the image data DATA through the third interface EPI3.

For example, the third low power driving signal LPTD3 may have a logic high level in a section corresponding to horizontal periods in which image data DATA is to be transmitted to pixel rows of the 3-2 display area A32 displaying the same gray scale, and a logic low level in other sections.

Here, while the transmission of the image data DATA is stopped, the third source-driven integrated circuit DIC3 may store a data signal generated based on the image data DATA of the i-th pixel row PXL(i) provided from the timing controller 110 in an embedded memory (or channel input buffer/line buffer), and repeatedly output data stored in the remaining pixel rows displaying the same gray scale of the 3-2-th display area A32, for example, the (i+1)th to (j−1)-th pixel rows PXL(i+1)-PXL(j−1).

Thereafter, in response to the horizontal period in which the image data DATA of the last pixel row, e. g., the (j−1)-th pixel row PXL(j−1), of the 3-2-th display area A32 displaying the same gray scale is to be transmitted, the timing controller 110 may output the clock training pattern through the third interface EPI3 to wake-up the third source driving integrated circuit DIC3, which is the corresponding source driving integrated circuit. Accordingly, the third source driving integrated circuit DIC3 may normally receive the image data DATA corresponding to the j-th to n-th pixel rows PXL(j) to PXL(n) from the third transmitter Tx3 of the timing controller 110 through the third interface EPI3.

As another example, as illustrated in FIG. 4, when the 1-1 display area A11 of the display area AA displays images of various gray scales, the 1-2 display area A12 of the first display area A1 displays images of the same gray scale, and the 1-3 display area A13 of the first display area A1 displays images of various gray scales, the timing controller 110 may transmit the image data DATA corresponding to the 1-1 display area A11 and the 1-3 display area A13 to the first source-driven integrated circuit DIC1, which provides data signals to the first display area A1, during the corresponding periods (shown as “EPI Tx On” in FIG. 4), and may stop at least part of the transmission of the image data DATA corresponding to the 1-2 display area A12 (shown as “EPI Tx Off” in FIG. 4).

For example, the first transmitter Tx1 included in the transmitter 112 of the timing controller 110 may transmit the image data DATA of the k-th pixel row PXL(k) to the first source-driven integrated circuit DIC1 through the first interface EPI1 in a k-th horizontal period within one frame.

Further, during the horizontal period in which the image data DATA of the remaining pixel rows, e.g., the (k+1)-th to (l−1)-th pixel rows PXL(k+1) to PXL(l−1) displaying the same gray scale of the 1-2-th display area A12 is to be transmitted, the first transmitter Tx1 may be driven at low power by stopping the transmission of the image data DATA through the first interface EPI1.

For example, the first low power driving signal LPTD1 may have a logic high level in a section corresponding to horizontal periods in which image data DATA is to be transmitted to pixel rows of the 1-2 display area A12 displaying the same gray scale, and a logic low level in other sections.

Here, while the transmission of the image data DATA is stopped, the first source-driven integrated circuit DIC1 may store a data signal generated based on the image data DATA of the kth pixel row PXL(k) provided from the timing controller 110 in a built-in memory (or channel input buffer) and repeatedly output the data signal stored in the remaining pixel rows displaying the same gray scale of the 1-2-th display area A12, for example, the (k+1)-th to (l−1)-th pixel rows PXL(k+1) to PXL(l−1).

Thereafter, in response to the horizontal period in which the image data DATA of the last pixel row, e. g., the (1-1)-th pixel row PXL(l−1) of the 1-2-th display area A12 displaying the same gray scale is to be transmitted, the timing controller 110 may wake up the first source driving integrated circuit DIC1, which is the corresponding source driving integrated circuit, by outputting a clock training pattern through the first interface EPI1. Accordingly, the first source-driven integrated circuit DIC1 may normally receive image data DATA corresponding to the first to n-th pixel rows PXL(l) to PXL(n) from the first transmitter Tx1 of the timing controller 110 through the first interface EPI1.

Meanwhile, in the case of the second display area A2 and the fourth display area A4 in the display area AA, images of various gradations are displayed in all pixel rows, for example, the first to n-th pixel rows PXL(1) to PXL(n), so the timing controller 110 may normally transmit image data DATA corresponding to all pixel rows to the second source-driven integrated circuit DIC2 and the fourth source-driven integrated circuit DIC4, which provide data signals to the second display area A2.

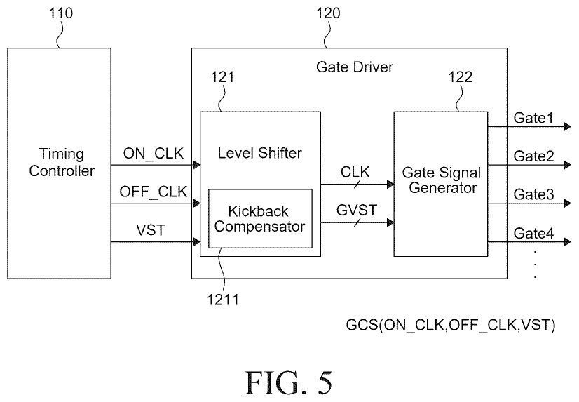

FIG. 5 is a block diagram illustrating an example of a timing controller and a gate driver included in a display device of FIG. 1.

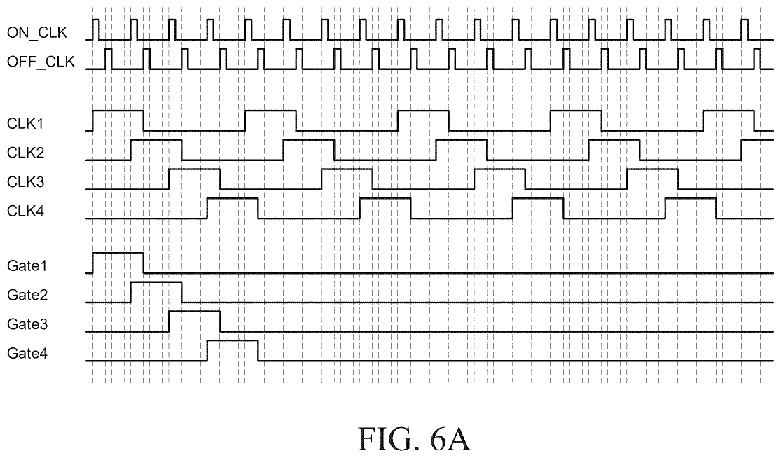

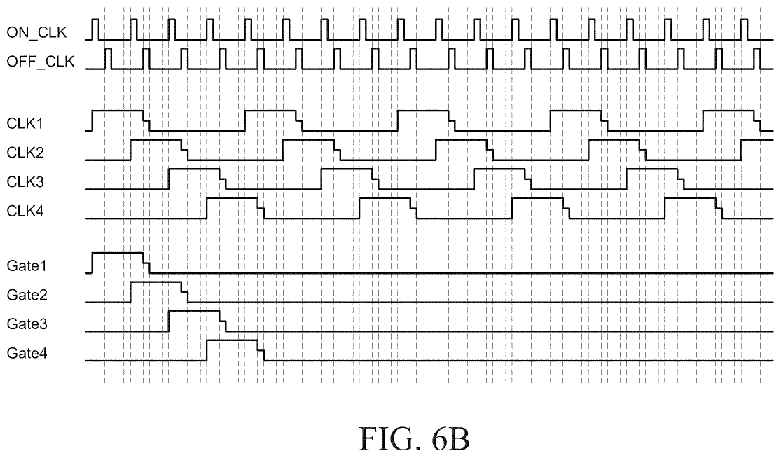

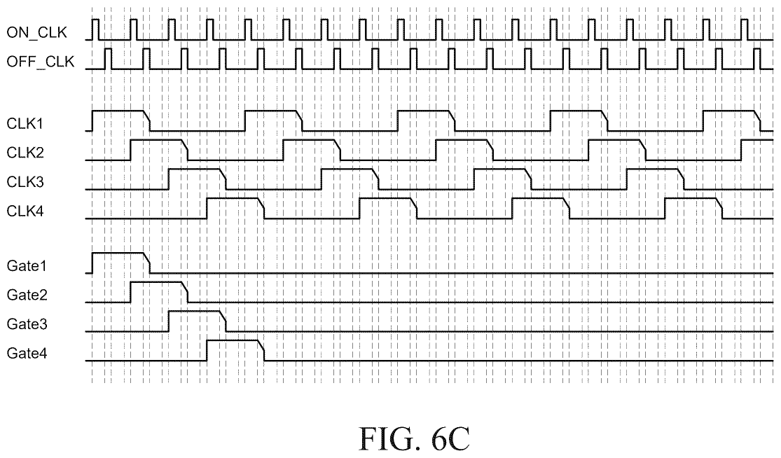

FIGS. 6A to 6C are waveform diagrams illustrating an example of the operation of the gate driver of FIG. 5.

Meanwhile, FIGS. 6A to 6C illustrate that the plurality of clock signals CLK generated by the level shifter 121 includes first to fourth clock signals CLK1 to CLK4, but this is illustrative and the number of clock signals CLK generated by the level shifter 121 may be variously modified.

Referring to FIGS. 1 and 5, the gate driver 120 generates a plurality of gate signals Gate1 to Gate4 based on a gate control signal GCS provided from the timing controller 110 and sequentially provides the gate signals to the plurality of gate lines GL.

To this end, in an embodiment, the gate driver 120 may include a level shifter 121 and a gate signal generator 122.

The level shifter 121 may generate a plurality of gate clock signals CLK and a gate start signal GVST based on a start signal VST, an on clock signal ON_CLK, an off clock signal OFF_CLK included in the gate control signal GCS provided from the timing controller 110, and provide the same to the gate signal generator 122.

The gate signal generator 122 may generate a plurality of gate signals Gate1 to Gate4 based on a plurality of gate clock signals CLK and a gate start signal GVST provided from the level shifter 121. For example, the gate signal generator 122 may include a shift register.

More specifically, referring to FIG. 6A, each of the on clock signal ON_CLK and the off clock signal OFF_CLK may include a plurality of pulses formed with a preset period. For example, each of the on clock signal ON_CLK and the off clock signal OFF_CLK may be a signal having a turn-on level and a turn-off level periodically. For example, the on clock signal ON_CLK and the off clock signal OFF_CLK may have the same period.

The level shifter 121 generates a plurality of gate clock signals CLK1 to CLK4 based on the on clock signal ON_CLK and the off clock signal OFF_CLK and shifts the voltage level of each of the plurality of gate clock signals CLK1 to CLK4 to a voltage level at which the transistor is operable to provide the voltage level to the gate signal generator 122.

For example, the level shifter 121 may generate a plurality of gate clock signals CLK1 to CLK4 having a rising edge and a falling edge corresponding to the rising edge or the falling edge of each of the on clock signal ON_CLK and the off clock signal OFF_CLK.

For example, as illustrated in FIG. 6A, the level shifter 121 may generate one pulse rising edge included in the first gate clock signal CLK1 in response to a first rising edge included in the on clock signal ON_CLK in one frame period, and generate a falling edge of the one pulse included in the first gate clock signal CLK1 in response to a second rising edge included in the off clock signal OFF_CLK.

Accordingly, the one pulse included in the first gate clock signal CLK1 may have a turn-on level pulse including a rising edge and a falling edge respectively corresponding to the first rising edge included in the on clock signal ON_CLK and the second rising edge included in the off clock signal OFF_CLK. Further, the first gate clock signal CLK1 is configured to give four pulses of an on clock signal ON_CLK and an off clock signal OFF_CLK to have pulses of a turn-on level in a similar manner.

Further, the level shifter 121 may generate the second to fourth gate clock signals CLK2 to CLK4 in a similar manner to the first gate clock signal CLK1. For example, the first to fourth gate clock signals CLK1 to CLK4 may have the same pulse width and the same period, and may have a waveform in which the phases do not overlap each other. For example, the second gate clock signal CLK2 may be set as a signal shifted by a period of an on clock signal ON_CLK and an off clock signal OFF_CLK in the first gate clock signal CLK1, the third gate clock signal CLK3 may be set as a signal shifted by a period of an on clock signal ON_CLK and an off clock signal OFF_CLK in the second gate clock signal CLK2, and the fourth gate clock signal CLK4 may be set as a signal shifted by a period of an on clock signal ON_CLK and an off clock signal OFF_CLK in the third gate clock signal CLK3.

The gate driver 120 may generate a plurality of gate signals Gate1 to Gate4 based on a plurality of gate clock signals CLK1 to CLK4 provided from the level shifter 121. For example, the gate driver 120 may generate a plurality of gate signals Gate1 to Gate4 having a turn-on level pulse corresponding to any one of the turn-on level pulses of each of the plurality of gate clock signals CLK1 to CLK4.

However, the embodiment of the present disclosure is not limited thereto, and the level shifter 121 may perform control so as to include a gate pulse modulation (hereinafter, referred to as “GPM”) period at a falling edge of each of a plurality of pulses included in each of the plurality of clock signals CLK1 to CLK4. In this case, the kickback phenomenon occurring in the pixel PX to which the gate signal is provided may be compensated. To this end, referring to FIG. 5, the level shifter 121 may further include a kickback compensator 1211.

Specifically, as illustrated in FIG. 6B, the level shifter 121 may generate a rising edge of one pulse included in the first gate clock signal CLK1 in response to a first rising edge included in the on clock signal ON_CLK in one frame period, and generate a falling edge of the one pulse included in the first gate clock signal CLK1 in response to a second falling edge included in the off clock signal OFF_CLK.

Accordingly, the one pulse included in the first gate clock signal CLK1 may have a turn-on level pulse including a rising edge and a falling edge respectively corresponding to the first rising edge included in the on clock signal ON_CLK and the second falling edge included in the off clock signal OFF_CLK.

Here, the kickback compensation unit 1211 may perform control so as to include a GPM period at the falling edge of the one pulse included in the first gate clock signal CLK1 during a period from a time point at which the second rising edge included in the off clock signal OFF_CLK is generated to a time point at which the second falling edge is generated. For example, as illustrated in FIG. 6B, the kickback compensator 1211 may control the one pulse included in the first gate clock signal CLK1 to be gradually decreased from the turn-on level to the turn-off level.

However, the embodiment of the present disclosure is not limited thereto, and as illustrated in FIG. 6C, the kickback compensator 1211 may perform control so that the one pulse included in the first gate clock signal CLK1 gradually decreases from the turn-on level to the turn-off level.

In addition, as described above, the first gate clock signal CLK1 is configured to give four pulses of an on clock signal ON_CLK and an off clock signal OFF_CLK to have pulses of a turn-on level in a similar manner. Further, as described above, the level shifter 121 may generate second to fourth gate clock signals CLK2 to CLK4 including a GPM period for each pulse in a manner similar to the first gate clock signal CLK1.

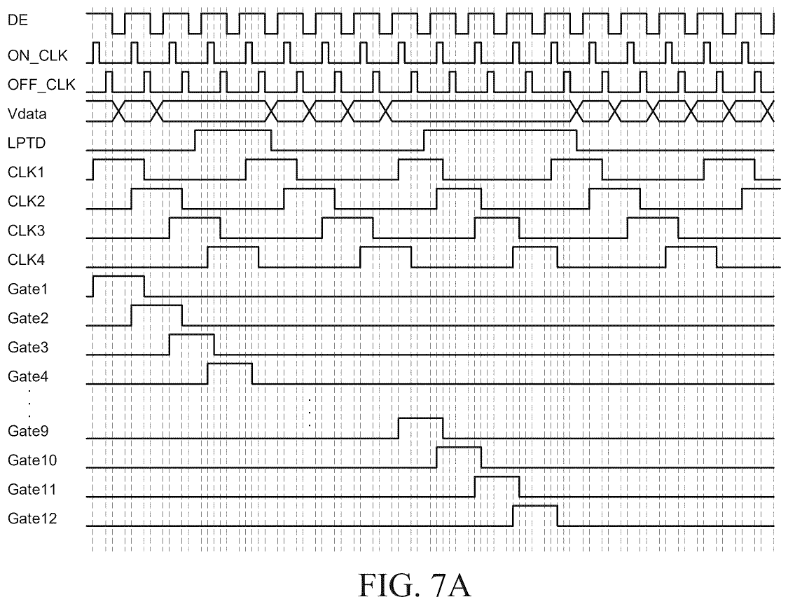

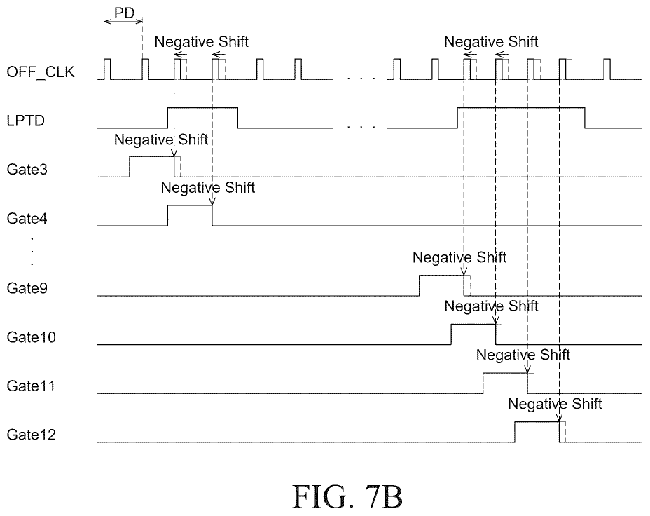

FIGS. 7A and 7B are waveform diagrams illustrating an example of a low-power exclusive driving operation of the timing controller and the gate driver of FIG. 5.

Referring to FIGS. 1 to 3, 5 and 7A, as described above, the timing controller 110 may determine whether to stop transmitting the image data DATA to the data driver 130 based on the signal level of the low power driving signal LPTD.

For example, as illustrated in FIG. 7A, in a section in which the low power driving signal LPTD is at a logic low level, the timing controller 110 normally transmits the image data DATA to the data driver 130, and the data driver 130 may output the data signal Vdata corresponding to the image data DATA provided from the timing controller 110.

In contrast, in a section where the low power driving signal LPTD is at a logic high level, the timing controller 110 stops transmitting the image data DATA to the data driver 130, and the data driver 130 may output a data signal stored in an embedded memory corresponding to a section where the low power driving signal LPTD is at a logic high level.

For example, as illustrated in FIG. 7A, the data driver 130 may output a data signal Vdata corresponding to the third horizontal line in response to the fourth horizontal line, and output a data signal Vdata corresponding to the ninth horizontal line in response to the tenth to twelfth horizontal lines, in response to a period in which the low power driving signal LPTD has a logic high level.

In an embodiment, in the low power transmission driving mode, the timing controller 110 may shift at least some of a plurality of pulses included in the off clock signal OFF_CLK provided to the gate driver 120. For example, the timing controller 110 may vary a pulse period of at least some of a plurality of pulses included in the off clock signal OFF_CLK.

For example, referring to FIG. 7B together, the timing controller 110 may shift at least one pulse included in the off clock signal OFF_CLK and overlapping a section in which the low power driving signal LPTD has a logic high level, in a negative direction (illustrated in FIG. 7B) among a plurality of pulses having a constant period PD.

For example, the timing controller 110 may shift a timing at which each of the rising edge and the falling edge of at least one pulse overlapping a section in which the low power driving signal LPTD has a logic high level, among a plurality of pulses included in the off clock signal OFF_CLK, occurs in a negative direction.

According to an embodiment, the timing controller 110 may shift each of the rising edge and the falling edge of the at least one pulse in a negative direction by a pulse width of each of a plurality of pulses included in the off clock signal OFF_CLK, but is not limited thereto. For example, the timing controller 110 may shift the rising edge and the falling edge of the at least one pulse in a negative direction by a multiple of a pulse width of each of a plurality of pulses included in the off clock signal OFF_CLK.

For example, as described with reference to FIG. 6A, when the falling edge of the pulse included in the gate clock signal CLK is generated corresponding to the rising edge included in the off clock signal OFF_CLK, as illustrated in FIGS. 7A and 7B, the falling edge of the turn-on level pulse of each of the third gate signal Gate3, the fourth gate signal Gate4, the ninth gate signal Gate9, the tenth gate signal Gate10, the eleventh gate signal Gate11, and the twelfth gate signal Gate12 may be shifted in the negative direction in response to the pulses shifted in the negative direction among the plurality of pulses included in the off clock signal OFF_CLK.

Meanwhile, a plurality of pulses included in the on clock signal ON_CLK provided from the timing controller 110 to the gate driver 120 may have a constant period PD without being shifted in a specific direction. Accordingly, the rising edge of the turn-on level pulse included in each of the plurality of gate signals is not shifted in a specific direction to correspond to the on clock signal ON_CLK and has a constant period, but the falling edge of the turn-on level pulse of the gate signal having the falling edge corresponding to the pulses shifted in the negative direction among the plurality of pulses included in the off clock signal OFF_CLK may be shifted in the negative direction. Accordingly, a pulse width of a gate signal overlapping a section in which the low power driving signal LPTD is a logic high level, that is, a gate signal supplied to a pixel row corresponding to a horizontal period in which the image data DATA is not transmitted from the timing controller 110 to the data driver 130 may be reduced.

As described above, even if the pulse width of the gate signal supplied to the pixel row corresponding to the horizontal period during which the image data DATA is not transmitted from the timing controller 110 to the data driver 130 decreases, the same data signal Vdata is supplied to the pixel row so that the data signal Vdata may be normally written to the pixel PX and the charging time decreases as the pulse width of the gate signal decreases, so that the power consumption of the gate driver 120 may be additionally reduced.

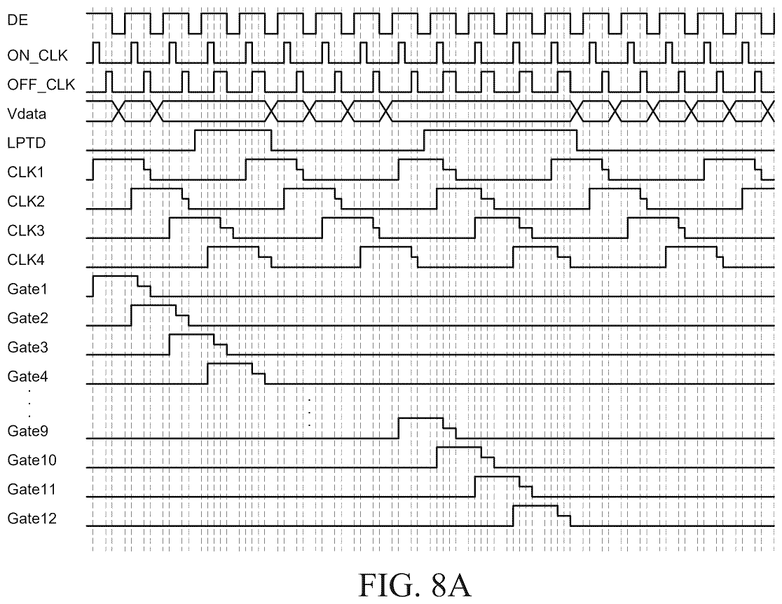

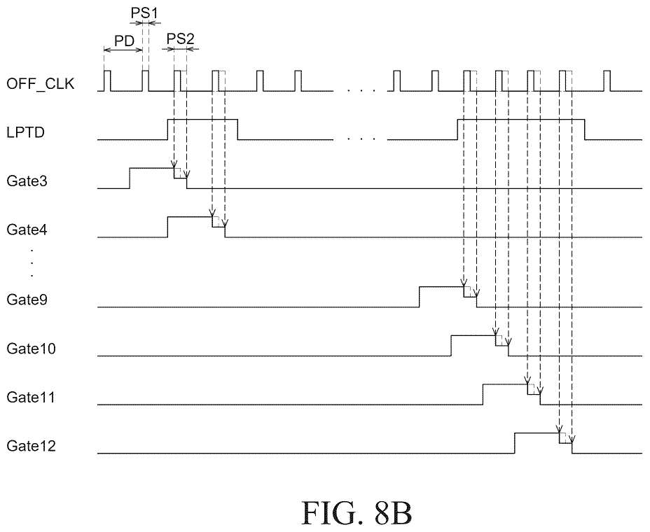

FIGS. 8A and 8B are waveform diagrams illustrating another example of a low-power exclusive driving operation of the timing controller and the gate driver of FIG. 5.

Meanwhile, FIGS. 8A and 8B illustrate modified embodiments of FIGS. 7A and 7B, and accordingly, redundant descriptions will not be repeated.

Referring to FIGS. 1 to 3, 5 and 8A, in a low power transmission driving mode, the timing controller 110 may vary a pulse width of at least some of a plurality of pulses included in an off clock signal OFF_CLK provided to the gate driver 120. For example, the timing controller 110 may increase a pulse width of at least some of a plurality of pulses included in the off clock signal OFF_CLK.

For example, referring to FIG. 8B together, the timing controller 110 may change a pulse width of at least one pulse included in the off clock signal OFF_CLK and overlapping a section in which the low power driving signal LPTD has a logic high level, among a plurality of pulses each having a first pulse width PS1, to a second pulse width PS2. For example, the second pulse width PS2 may be greater than the first pulse width PS1. For example, the second pulse width PS2 may be twice the first pulse width PS1, but is not limited thereto and the second pulse width PS2 may be variously set.

For example, the timing controller 110 may shift a timing at which a rising edge of at least one pulse overlapping a section in which the low power driving signal LPTD has a logic high level, among a plurality of pulses included in the off clock signal OFF_CLK, occurs in a negative direction. Here, the timing at which the polling edge of the at least one pulse occurs may not be shifted in a specific direction. That is, the polling edge of the at least one pulse may be fixed. Accordingly, a pulse width of the at least one pulse overlapping a section in which the low power driving signal LPTD has a logic high level, among a plurality of pulses included in the off clock signal OFF_CLK, may be increased.

According to an embodiment, the timing controller 110 may shift the rising edge of the at least one pulse in a negative direction by the pulse width of each of a plurality of pulses included in the off clock signal OFF_CLK, but is not limited thereto. For example, the timing controller 110 may shift the rising edge of the at least one pulse in a negative direction by a multiple of the pulse width of each of the plurality of pulses included in the off clock signal OFF_CLK.

In this case, the falling edge of the at least one pulse among a plurality of pulses included in the off clock signal OFF_CLK is not shifted in a specific direction, but is fixed, and only the rising edge is shifted in a negative direction, so the pulse width of the at least one pulse may increase. For example, the pulse width of the at least one pulse may increase by the degree to which the rising edge is shifted.

For example, as described with reference to FIG. 6B, when the falling edge of the pulse included in the gate clock signal CLK is generated corresponding to the falling edge included in the off clock signal OFF_CLK, as illustrated in FIGS. 8A and 8B, in response to pulses having a variable pulse width among a plurality of pulses included in the off clock signal OFF_CLK, the falling section of the pulse at the turn-on level of each of the third gate signal Gate3, the fourth gate signal Gate4, the ninth gate signal Gate9, the tenth gate signal Gate10, the eleventh gate signal Gate11, and the twelfth gate signal Gate12 may increase.

Accordingly, the GPM period of the gate signal overlapping the section in which the low power driving signal LPTD is at the logic high level, that is, the gate signal supplied to the pixel row corresponding to the horizontal period in which the image data DATA is not transmitted from the timing controller 110 to the data driver 130 may increase.

As described above, even if the GPM section of the gate signal supplied to the pixel row corresponding to the horizontal period during which the image data DATA is not transmitted from the timing controller 110 to the data driver 130 increases, the same data signal Vdata is supplied to the pixel row so that the data signal Vdata may be normally written to the pixel PX and the charging time decreases as the GPM section of the gate signal increases, so that the power consumption of the gate driver 120 may be further reduced.

In the meantime, even though in FIGS. 8A and 8B, it is illustrated that the pulse of the turn-on level included in the gate signal is gradually decreased in the GPM period, the example embodiment of the present disclosure is not limited thereto. As described with reference to FIG. 6C, the pulse of the turn-on level included in the gate signal may be gradually decreased in the GPM period.

As described above, in the display device 100 according to the example embodiment of the present disclosure, when a plurality of pixel rows display an image of the same gradation, transmission of image data corresponding to at least some of the plurality of pixel rows displaying an image of the same gradation may be stopped. Accordingly, power consumption for data transmission may be reduced.

Further, during the period in which the image data transmission is stopped, the display device 100 according to the example embodiment of the present disclosure may shift the off clock signal, among the on clock signal and the off clock signal for generating the gate signal, in a specific direction. Accordingly, the falling edge of the gate signal is shifted in response to the off clock signal to reduce the pulse width of the gate signal so that the power consumption of the gate driver 120 may be further reduced.

Further, during the period in which the image data transmission is stopped, the display device 100 according to the example embodiment of the present disclosure may increase the pulse width of the off clock signal among the on clock signal and the off clock signal for generating the gate signal. Accordingly, the gate pulse modulation (GPM) section is increased at the falling edge of the gate signal in response to the pulse width of the off clock signal so that the power consumption of the gate driver 120 may be further reduced.

The example embodiments of the present disclosure can also be described as follows:

According to an aspect of the present disclosure, a display device includes a timing controller configured to generate image data, a data control signal, and a gate control signal, a data driver configured to generate a plurality of data signals corresponding to the image data and output the data signals to a plurality of data lines based on the gate control signal, a gate driver configured to generate a plurality of gate signals and output the gate signals to a plurality of gate lines, and a display panel including a plurality of pixels disposed in the display area and connected to the plurality of data lines and the plurality of gate lines, wherein the timing controller stops transmission of the image data in a section in which the low power driving signal is a logic high level, and the gate driver may modulate a gate signal having a turn-on level pulse in which the low power driving signal among the plurality of gate signals overlaps the section in which the low power driving signal is a logic high level.

According to another feature of the present disclosure, the gate driver may include a level shifter configured to generate a plurality of gate clock signals based on an on clock signal and an off clock signal included in a gate control signal, and a gate signal generator configured to generate a plurality of gate signals based on the plurality of gate clock signals.

According to another feature of the present disclosure, the gate driver may reduce a pulse width of a gate signal having a turn-on level pulse overlapping a period in which a low power driving signal among a plurality of gate signals is a logic high level.

According to another feature of the present disclosure, the timing controller may negatively shift a pulse overlapping a section in which the low power driving signal is a logic high level, among a plurality of pulses included in the off clock signal.

According to another feature of the present disclosure, a polling edge of a gate signal having a polling edge corresponding to a pulse included in an off clock signal and shifted in a negative direction, among a plurality of gate signals, may be shifted in a negative direction.

According to another feature of the present disclosure, a rising edge of each of the plurality of gate signals may be fixed.

According to another feature of the present disclosure, the timing controller may shift a pulse overlapping a section in which the low power driving signal is a logic high level, among a plurality of pulses included in the off clock signal, by a pulse width of each of a plurality of pulses included in the off clock signal.

Each of the plurality of gate signals includes a gate pulse modulation period in which the signal level decreases stepwise or gradually at the polling edge, and the gate driver may vary the length of the gate pulse modulation period of the gate signal having a turn-on level pulse overlapping the period in which the low power driving signal among the plurality of gate signals is a logic high level.

According to another feature of the present disclosure, the timing controller may increase a pulse width of a pulse overlapping a section in which the low power driving signal is a logic high level, among a plurality of pulses included in the off clock signal.

According to another feature of the present disclosure, the timing controller may shift the rising edge of the pulse overlapping the section in which the low power driving signal is the logic high level, among a plurality of pulses included in the off clock signal, in the negative direction.

According to another feature of the present disclosure, a gate pulse modulation period of a gate signal included in an off clock signal among a plurality of gate signals and having a falling edge corresponding to a pulse with an increased pulse width may increase.

According to another feature of the present disclosure, the timing controller may double a pulse width of a pulse overlapping a section in which the low power driving signal is a logic high level, among a plurality of pulses included in the off clock signal.

According to another feature of the present disclosure, the timing controller may shift a rising edge of a pulse overlapping a section in which the low power driving signal is a logic high level, among a plurality of pulses included in the off clock signal, by a pulse width of each of a plurality of pulses included in the off clock signal.

According to another feature of the present disclosure, the low power driving signal may have a high logic level corresponding to a horizontal period corresponding to at least two pixel rows displaying an image of the same gray scale among a plurality of pixel rows of the display area.

According to an aspect of the present disclosure, a display device includes a timing controller configured to generate image data, a data control signal, and a gate control signal; a data driver configured to generate a plurality of data signals corresponding to the image data based on the image data and the data control signal; and a gate driver configured to generate a plurality of gate signals based on an on clock signal and an off clock signal included in the gate control signal, wherein the timing controller stops transmission of the image data in a section in which the low power driving signal is a logic high level, and the timing controller may modulate a pulse in which the low power driving signal overlaps the logic high level, among a plurality of pulses included in the off clock signal.

According to another feature of the present disclosure, the timing controller may shift a pulse overlapping a section in which the low power driving signal is the logic high level, among a plurality of pulses included in the off clock signal, in the negative direction.

According to another feature of the present disclosure, the timing controller may increase a pulse width of a pulse overlapping a section in which the low power driving signal is a logic high level, among a plurality of pulses included in the off clock signal.

Although the example embodiments of the present disclosure have been described in detail with reference to the accompanying drawings, the present disclosure is not limited thereto and may be embodied in many different forms without departing from the technical concept of the present disclosure. Therefore, the example embodiments of the present disclosure are provided for illustrative purposes only but not intended to limit the technical concept of the present disclosure. The scope of the technical concept of the present disclosure is not limited thereto. Therefore, it should be understood that the above-described example embodiments are illustrative in all aspects and do not limit the present disclosure. All the technical concepts in the equivalent scope of the present disclosure should be construed as falling within the scope of the present disclosure.

What is claimed is:

1. A display device, comprising:
a timing controller configured to generate image data, a data control signal, and a gate control signal;
a data driver configured to generate a plurality of data signals corresponding to the image data and output the plurality of data signals to a plurality of data lines based on the image data and the data control signal;
a gate driver configured to generate a plurality of gate signals and output the plurality of gate signals to a plurality of gate lines based on the gate control signal; and
a display panel having a display area and including a plurality of pixels connected to the plurality of data lines and the plurality of gate lines,
wherein the timing controller is configured to stop transmission of the image data in a section in which a low power driving signal is a logic high level, and
wherein the gate driver is configured to modulate a gate signal having a turn-on level pulse overlapping the section in which the low power driving signal is the logic high level.

2. The display device according to claim 1, wherein the gate driver includes:
a level shifter configured to generate a plurality of gate clock signals based on an on clock signal and an off clock signal included in the gate control signal; and
a gate signal generator configured to generate the plurality of gate signals based on the plurality of gate clock signals.

3. The display device according to claim 1, wherein the gate driver is configured to reduce a pulse width of the gate signal having the turn-on level pulse overlapping a period in which the low power driving signal among the plurality of gate signals is a logic high level.

4. The display device according to claim 2, wherein the timing controller is configured to shift a pulse overlapping a section in which the low power driving signal is a logic high level, in a negative direction, among a plurality of pulses included in the off clock signal.

5. The display device according to claim 4, wherein the gate signal has a falling edge, and wherein the falling edge corresponding to the pulse shifted in the negative direction, included in the off clock signal among the plurality of gate signals, is shifted in the negative direction.

6. The display device according to claim 4, wherein a rising edge of each of the plurality of gate signals is fixed.

7. The display device according to claim 2, wherein the timing controller is configured to shift the pulse overlapping a period in which the low power driving signal is the logic high level, among the plurality of pulses included in the off clock signal, by a pulse width of each of the plurality of pulses included in the off clock signal.

8. The display device according to claim 2, wherein each of the plurality of gate signals includes a gate pulse modulation period in which a signal level decreases stepwise or gradually at a polling edge, and
wherein the gate driver is configured to vary a length of the gate pulse modulation period of the gate signal having the turn-on level pulse in which the low power driving signal of the plurality of gate signals overlaps a logical high level period.

9. The display device according to claim 2, wherein the timing controller is configured to increase a pulse width of the pulse overlapping the section in which the low power driving signal is the logic high level, among the plurality of pulses included in the off clock signal.

10. The display device according to claim 2, wherein the timing controller is configured shift a rising edge of the pulse overlapping the section in which the low power driving signal is the logic high level, in a negative direction, among the plurality of pulses included in the off clock signal.

11. The display device according to claim 2, wherein a gate pulse modulation period of the gate signal which is included in the off clock signal among the plurality of gate signals and has a falling edge corresponding to a pulse with an increased pulse width is increased.

12. The display device according to claim 2, wherein the timing controller is configured double a pulse width of the pulse overlapping the section in which the low power driving signal is the logic high level, among the plurality of pulses included in the off clock signal.

13. The display device according to claim 2, wherein the timing controller is configured to shift a rising edge of the pulse overlapping the section in which the low power driving signal is the logic high level, among the plurality of pulses included in the off clock signal by a pulse width of each of the plurality of pulses included in the off clock signal.

14. The display device according to claim 1, wherein the low power driving signal has a logic high level corresponding to a horizontal period corresponding to at least two pixel rows displaying an image of a same gray scale among a plurality of pixel rows of the display area.

15. A display device, comprising:
a timing controller configured to generate image data, a data control signal, and a gate control signal;
a data driver configured to generate a plurality of data signals corresponding to the image data based on the image data and the data control signal; and
a gate driver configured to generate a plurality of gate signals based on an on clock signal and an off clock signal included in the gate control signal,
wherein the timing controller is configured to stop transmission of the image data in a section in which a low power driving signal is a logic high level, and
wherein the timing controller is configured to modulate a pulse in which the low power driving signal overlaps a section among a plurality of pulses included in the off clock signal.

16. The display device according to claim 15, wherein the timing controller is configured to shift the pulse overlapping the section in which the low power driving signal is the logic high level, in a negative direction, among the plurality of pulses included in the off clock signal.

17. The display device according to claim 15, wherein the timing controller is configured to increase a pulse width of the pulse overlapping the section in which the low power driving signal is the logic high level, among the plurality of pulses included in the off clock signal.
